(19) United States
(12) Patent Application Publication
(10) Pub. No.: US 2003/0008409 A1
(43) Pub. Date: Jan. 9, 2003

(54) Method and apparatus for determining sunlight exposure

(76) Inventors: Steven R. Spearman, Alpharetta, GA (US); Scott Kevin Spearman, Madison, AL (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/189,816

(22) Filed: Jul. 3, 2002

Related U.S. Application Data
(60) Provisional application No. 60/303,254, filed on Jul. 3, 2001.

(51) Int. Cl. G01N 31/22; G01N 31/00

(52) U.S. Cl. 436/169; 422/56; 436/57

(57) ABSTRACT

A method and apparatus for determining the amount of sunlight a certain location receives in a given time, wherein the device incorporates photochromic dyes that are coated, applied or impregnated on the device substrate, and wherein each dye possesses different levels of activation for indication of different amounts of sunlight received.

### CROSS-REFERENCES TO RELATED APPLICATIONS

This application claims priority to, and the benefit of, date of Provisional Application No. 60/303,254, filed Jul. 3, 2001, entitled “Method and Apparatus for Determining Sunlight Exposure”.

### TECHNICAL FIELD

The present invention relates generally to light exposure, including sunlight and synthetic light, and properties, effects, and benefits relating to such light exposure and more particularly to a method and apparatus for determining sunlight exposure.

### BACKGROUND OF THE INVENTION

The amount of light exposure provided at a particular location of a person's property, whether inside or outside, affects the types of plants that will thrive at such location. Thus it is desirable to know such exposure for use in selection, planting and care of such plants.

U.S. Pat. No. 3,779,651 to Gunlock, teaches the use of light-sensitive material having a filtered cover. A color change in the light-sensitive material corresponds to a given reference color that has been printed on the substrate. Gunlock requires the use of a color reference for comparison of the light-activated material in order to determine the quantity of radiation to which the light-sensitive material has been exposed. A legend is used to identify by color the different plants that are best suited for growing in the subject light intensity. In one embodiment, Gunlock teaches a disc that only has a certain portion exposed in a window, such that a segment of the disc can be rotated into the exposure window position. The reference color is imprinted adjacent to the exposed disc area on a non-rotating surface, wherein the surface defines one limit of the exposure window. Gunlock alternately uses strips that may be exposed under a filter and placed adjacent to the printed reference colors. The invention of Gunlock requires at least three component parts that must be assembled in order to form the movable disc. In the alternative embodiment, which also requires the assembly of several component parts, Gunlock requires the user to pull the strip into the reference area up to a specific notch. The requirement of user input to set up the operation of the disc or the pull strips, coupled with the complexity of manufacture, would render the Gunlock invention labor intensive in use and relatively costly to manufacture. Additionally, because the reference portion of the Gunlock device is continuously exposed to light, while the portions to be later activated are shielded from light, the reference portion will be subject to fading, and consequently leads to erroneous results. Furthermore, it should also be noted that the Gunlock device requires a filter to function.

U.S. Pat. No. 4,168,124 to Pizzi describes the use of electronic sensors to detect and quantify the level of sunlight integrated over a period of time. Such a method would have great accuracy, but due to its complexity, it is not suitable for everyday use for a large number of applications.

U.S. Pat. No. 4,126,417 to Edwards teaches a device in the form of a stick that detects and quantifies pH and various nitrate levels present in soil. Although the Edwards device utilizes colored sections for indication or measurement of such pH levels and nitrate levels, the Edwards device is disadvantageous, as it does not measure levels of sunlight exposure.

U.S. Pat. No. 2,337,534 to Barber teaches a disc or sheet of photosensitive paper that darkens when exposed to light for the purpose of monitoring exposure time of the pages of a book. Barber's invention, however, is suitable for brief exposures lasting only a few seconds, wherein the level of exposure is determined by the intensity of the blackening of the photographic light sensitive paper. As such, utilization of the Barber device may yield limited and/or inaccurate measurements. Therefore, it is readily apparent that there is a need for a method and apparatus for determining sunlight exposure that provides a simple, accurate determination of the sunlight level at a given area over time.

U.S. Pat. No. 6,132,681 to Faran et al., which is incorporated herein by reference, describes a disposable dosimeter for measuring human exposure to ultraviolet radiation. Although Faran teaches the use of at least one active chemical in combination with a color enhancing agent, for color change measurement at higher temperatures, Faran is disadvantageous as it is limited to measurement of human exposure to ultraviolet radiation only.

### BRIEF SUMMARY OF THE INVENTION

Briefly described, the present invention overcomes the above-mentioned disadvantages and meets the recognized need for such a device by providing a method and apparatus for determining sunlight exposure, wherein the device accurately and efficiently determines an object's exposure to sunlight via color change that is readily identifiable.

According to its major aspects and broadly stated, the present invention in its preferred embodiment is a disc or stick upon which has been coated or impregnated bands or rings of a photosensitive dye.

More specifically, the present invention is made of a single component made from a substrate that has been coated in select areas with a photosensitive dye or dyes that are light-intensity specific. With its one-piece construction, the present invention is simple to use in the field and does not require any input other than observation, once it is in use.

The present invention relates to a device which could be used by the lawn and garden industry or by the do-it yourself home gardener to determine the amount of sunlight exposure a particular area of a lawn, garden, or room location would receive in a day. This information could be used to determine what types of plants would do well in that area based on the measure. The results could then be entered into a database (possibly Internet-based), which would suggest specific plants based on the results of the measurement. The device could be useful to the retail plant or gardening industry not only as a viable retail product but could be color coded to a tag on the plants which could potentially reduce the need for interventions by, and questions to, sales people.

A feature and advantage of the present invention is its ability to provide a device for measurement of light intensity over a period of time, wherein the device readily and unambiguously identifies a specific integrated light exposure level.

A further feature and advantage of the present invention is its ease of use and manufacture, requiring a minimum amount of components.

A feature and advantage of the present invention is suitability for use indoors or outdoors.

A further feature and advantage of the present invention is its ability to enable the results to be matched to the light requirements of particular plants in order to determine optimal growing locations for such plants.

A further feature and advantage of the present invention is its ability to identify plants that are suitable for growth in a given area, wherein such identification is accomplished via a database describing specific light conditions for such plants.

A feature and advantage of the present invention is its ability to retrieve information from a compiled database via the Internet.

A feature and advantage of the present invention is its ability to provide a device that measures sunlight.

These and other objects, features and advantages of the present invention will become more apparent to one skilled in the art from the following description and claims when read in light of the accompanying drawings.

The device may be designed as either single use (irreversible) or reusable (reversible). Thus the single use would be disposed of after use.

### BRIEF DESCRIPTION OF THE DRAWINGS

Having thus described the invention in general terms, the present invention will be better understood by reading the Detailed Description of the Preferred and Alternate Embodiments with reference to the accompanying drawing figures, which are not necessarily drawn to scale, and in which like reference numerals denote similar structures and refer to like elements throughout, and in which:

FIG. 1 is an illustrative view of a device according to the present invention in an exterior location.

FIG. 2 is a plan view of a device of the present invention.

### DETAILED DESCRIPTION OF THE PREFERRED AND ALTERNATIVE EMBODIMENTS

In describing the preferred and alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

Photochromism is a light-induced reversible transformation of a chemical species due to absorption of electromagnetic radiation, which is most commonly seen in vision glasses that darken in sunlight and become transparent once they are in less intense light. Originally, these glasses had silver salts incorporated or integrated within them, but more recently organic photochromic lenses have been produced. Photochromism may also be used to indicate the chemical change that has taken place and may be quantitative. A given amount of light, as determined by intensity and duration, will convert a photochemical over to a different state which may have a different color, opaqueness, transparency, darkening, or other such change associated with it. Such a photochromic chemical may be included in a device for measuring light, in particular, sunlight. Organic photochromic compounds may be included in a polymer matrix that is then used to fabricate the indicator device.

The chemical change that typically occurs with organic photochromic compounds may be a bleaching of a colored material in daylight and the regeneration of the color in the dark. Photochromism may be associated with systems absorbing from the far ultraviolet to infrared. Reaction times may be short or long, dependent upon the chemical selected, its concentration, and the matrix it is in.

Heretofore, photochromic compounds were unstable and of limited potential use. More recently stable compounds have appeared.

By using a dye applied to a substrate as an indicating means, the present invention achieves a visual indication of light absorbed. Particularly suited photochromic dye chemicals are the spiropyrans and their derivatives, fulgides, aromatic o-Nitro derivatives, 2,3,4,4-tetrachloro-1-oxo-1,4-dihydronaphthalen derivatives, Bis-Imidazoles derivatives, bis-pyrroles derivatives, or Azasuccinic anhydride derivatives, and diarylethenes. Also suitable are chemical compounds such as 1,2-dibromotetrachloroethane, which when incorporated in a polymer matrix with methyl orange, changes its pH upon irradiation by UV-B light. This pH change causes a change in the color of the indicator from yellow to orange. Diphenylpicrylhydrazyl derivative is also suitable and is activated by light in the visible and UV ranges. This compound changes from violet or black to yellow upon adequate exposure.

The exposure level of a compound to provide change is based on the quantity of the photosensitive material. Accordingly, the strength of its visual indication is also proportionate to its concentration in the matrix.

Other compounds suited for use as actinometers, or devices for measuring the intensity of electromagnetic radiation, are ferroorganics, particularly ferrioxalate. Also suitable is mercury-dithizone complex, which changes from orange to blue on UV absorption and may be used as a dosimeter for UV exposure.

Silver oxalate/mercurous oxalate has been incorporated into a gelatin matrix, changing from white to brown upon exposure to light. Ferric oxalate may also be used.

Any polymer in which the photochromic chemical can be adequately dispersed or dissolved is suitable as a substrate. Suitable polymers include polycarbonates, polystyrenes, polyolefins, polyacrylates, polyvinyl derivatives, polyester derivatives, polyvinyl chloride, cellulose derivatives, polyurethane, polyethylene terephthalate, silicone resins, triethylene glycol dimethacrylate, polymethylmethacrylate and epoxy resins. Polymethylmethacrylate is particularly suited as a matrix and is easily fabricated into discs or strips.

Irradiance is defined as the total amount of radiative flux incident upon a point on a surface from all directions above the surface. Radiant flux density has the units Watts per square meter (W/m²). In the course of a day, there are 86,400 seconds. Thus a given radiant flux density over a 24-hour period will be 86400 W-s/m²-day. By incorporating the surface area of the measuring device, the units can be reduced to 86400 W-s/day, wherein Watt-seconds is a measure of energy. This energy is used to convert the dye chemical to its alternate state, such as from colored to bleached out or from one color to another. Conversion of one mole of a dye will require a given amount of energy. The quantity of energy required will be specific to the dye selected. Thus the amount of sunlight energy will activate an amount of dye adequate to constitute a color change dependent upon the dye used and its concentration. In this fashion, by selecting different dyes, a reaction will take place for each different dye at different levels of energy received. This may be expressed in the quantity of the dye converted to moles. Thus, by selecting dyes of different color, the quantity of irradiance in the selected time period can be determined. Since many photochemical dyes typically bleach out, the amount of radiation could also be determined by how many, and which, of the dye bands have bleached out. Thus, even a colorblind person would be able to determine the level of irradiance received by the disc and thus by the target area.

The present invention measures the amount of light exposure a particular area receives in a day by using photochromic dyes coated on a substrate. The coating may be a dispersion or solution of the dye in a polymer or alternatively the entire device may be fabricated from the polymer/photochromic chemical matrix. In the instance of sunlight, the invention may be placed in a particular location and left exposed to the sun during the day. The invention provides an immediate and accurate measure of the amount of sunlight that the target area received during daylight hours. While this measurement could be either a time unit of measure such as hours or minutes, and/or some other meaningful and useful measure, it is preferred that the measurement identify the quantity of light received by the target area over unit time, such as, for exemplary purposes only, 24 hours.

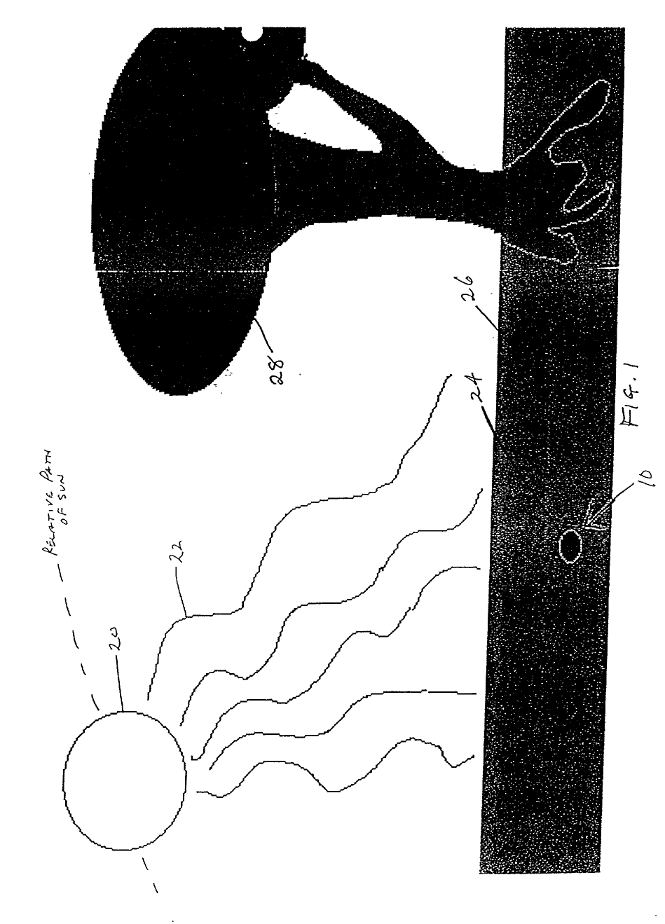

By reference to FIG. 1, device 10 is shown as a disc 24. It is contemplated that device 10 may be in various forms including a stick or rod, in addition to a disc 24. As the sun 20 travels along its path through the sky, the sun's rays 22 travel downward either through clear sky or impeded by a light barrier 28 such as a tree. By placing disc 24 on the ground surface 26 where the plant is destined to be placed, the measurement of the photon flux impinging on the ground surface 26 over time in that area can be determined. The conditions, such as Summer or Winter use, and the time of exposure, such as one day, one week or one month, would be identified on the device.

The photon flux causes a photochemical reaction to take place in the target dyes that have been coated on disc 24. Depending on the level of intensity integrated over a specific time period, the various dyes on disc 24 will bleach out or otherwise change color. Dyes that do not receive enough exposure on disc 24 will not bleach out or change color. By selecting dyes to provide quantitative levels at which sunlight exposure can be determined, an approximate determination can be made of the amount of sunlight received by a given exposed area on disc 24. In one embodiment of the present invention, dyes would be selected to provide bands or rings that range from less than 5 mol/day to more than 30 mol/day.

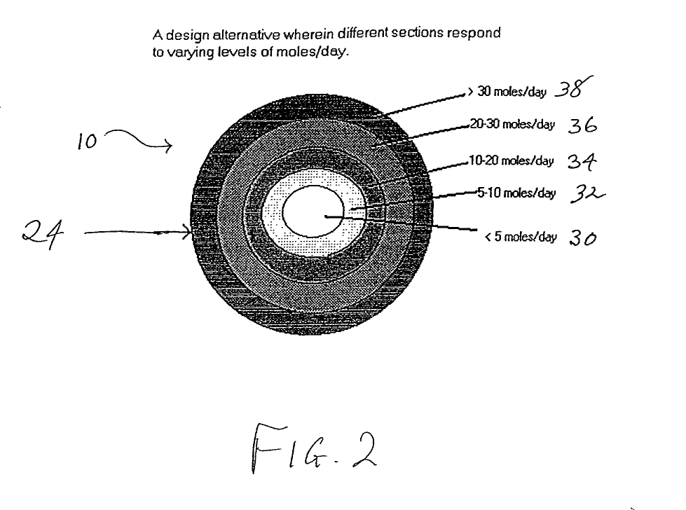

Referring to FIG. 2 disc 24 preferably possess rings or bands 30-38. It is contemplated in an alternative embodiment that disc 24 may possess any number of rings or bands. Inner non-exposure bull's eye 30 preferably indicates less than 5 mol/day and preferably requires no dye for this activation level as the background of disc 24 preferably provides a suitable coloration, wherein the background is preferably white, or any other suitable color as known in the art. Band 32 is preferably a 5 to 10 mol/day band and is preferably coated or applied with a photochromic chemical/polymer matrix that preferably activates at light exposures that are minimal, but still above the minimum 5 mol/day level.

Following band 32 is concentric band 34 that is preferably representative of a moderate exposure in the range of 10 to 20 mol/day. Preferably following band 34 is band 36, wherein band 36 is representative of 20 to 30 mol/day, which would be indicative of a moderately high exposure. Preferably, the outermost band or ring would be representative of a high exposure, greater than 30 mol/day 38. It is contemplated in an alternative embodiment that bands 30-38 could possess any suitable photochromic chemical/polymer matrix as known within the art.

Preferably, the results of light activated bands 30-38 are color-coded and matched to a separate color template or scale to determine the results and/or could alternatively be engineered to have the results appear on device 10 itself.

The device may be fashioned as a disc with concentric indicator rings or as a stick with indicating bands.

Device 10 is preferably temperature insensitive as the goal is to measure exposure to direct sunlight unaffected by temperature.

Although device 10 is preferably a disc 24, it is contemplated that may take several different forms, such as, for exemplary purposes only, a plastic square, rectangle or oval that is laid on the ground. The device is made by being molded, cast or pressed. Another embodiment contemplates the use of a stick or rod, with bands of dyes applied sequentially thereon that are inserted into the ground for stability. As the primary application of the device would be to assist in gardening and other botanical endeavors, if a stick or rod is employed, then the rod could in one embodiment be designed to incorporate a device to take a soil pH measure as well using a chemical that changes color with pH. In an alternate embodiment, the device could incorporate a sensor to test the moisture of the ground in the area, such as by use of chemical components that mix when wet to cause a color change, in conjunction with or instead of the pH reading.

It is contemplated in another alternative embodiment that the device 10 is reusable or designed for single use. Device 10 may also be designed to allow for exposure to the sun for measurement purposes over several days for a potentially more accurate measurement.

It is contemplated in yet another alternative embodiment that device 10 could be modified to be utilized in artificial or synthetic light and thus would be usable indoors in order to measure the light requirements of houseplants, wherein device 10 would not necessarily be limited in scope to measure direct sunlight but could measure the amount of light required by certain types of houseplants.

Device 10, as needed, could also be modified to measure direct sunlight, ambient sunlight, artificial light and/or a combination of all three for the provision of meaningful data to a botanist or houseplant owner, wherein device 10 could possess a suitable photochemical or photoelectric process or a combination of a photochemical and photoelectric process, or any other process known within the art, for allowing a human to interpret the output result of device 10 for determining the amount of light exposure received by the device 10.

Therefore, it may be understood that the invention contemplates the provision and use of a device to determine the amount of sunlight a certain location receives in a given time, thus providing the sunlight equivalent of a “rain gauge”. The invention also contemplates the use of the device with color-coding used to distinguish between exposure rates such as one color for “full sun”, another for “partial shade”.

It is contemplated in an alternative embodiment that device 10 may be part of a tag on a plant, wherein the tag would function as a color-coded indicating means to determine the suitability of the area for planting the plant.

In an additional alternative embodiment, device 10 may also be specified for use only on days with specific conditions, such as full sunlight, or over a specific time period such as 24 hours, one week, one month, and so on.

Although device 10 of the present invention functions to identify the quantity of light that falls on a given location for comparison to the amount of light required by a variety of plants, it is contemplated in an alternative embodiment that a single indicator device 10 may be tailored to a given species of plant, wherein the indicator device 10 could then be placed in the target area to determine whether such target area is suitable for the given plant species.

Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

What is claimed is:

1. An indicating device comprising a means for determining the amount of sunlight that a certain location receives in a given time, said device further comprising at least one substrate and at least one dye applied to said at least one substrate.

2. The indicating device of claim 1, wherein said at least one dye has been impregnated into said substrate.

3. The indicating device of claim 1, wherein said at least one dye has been coated on said substrate.

4. The indicating device of claim 1, wherein said substrate is disc-shaped.

5. The indicating device of claim 1, wherein said substrate is in the form of a stick or rod.

6. The indicating device of claim 1, further comprising a means for providing pH readings.

7. The indicating device of claim 1, further comprising a means for providing moisture readings.

8. The indicating device of claim 1, further comprising a means for providing pH readings and a moisture reading.

9. The indicating device of claim 1, further characterized by use of a color-coding means to distinguish between exposure rates.

10. An indicating device of claim 1, further comprising a tag means that is color-coded to a specific plant for determining the amount of light received in a specific period of time.

11. The indicating device of claim 1, further comprised of a means for selecting plants by reference to a database to supply appropriate plant information.

12. The indicating device of claim 11, wherein said database is accessible using the Internet.

13. The indicating device of claim 1, wherein the said device is disposable.

14. The indicating device of claim 1, wherein said device is reusable.

15. A method for determining the amount of sunlight that a certain location receives in a given time comprising the steps of providing a location for placement of an indicating device, providing said device, and defining the conditions in which said device may be used.

16. A method for determining the amount of sunlight that a certain location receives in a given time comprising the steps of providing a location for placement of an indicating device, providing said device, and defining the time period in which said device may be used.

17. The indicating device of claim 1, wherein said device is suitable for use in an interior location.

18. The indicating device of claim 1, wherein said device is suitable for use in an exterior location.

19. The indicating device of claim 16, wherein said device is capable of sensing synthetic light in conjunction with natural light.

20. The indicating device of claim 16, wherein said device is capable of sensing synthetic light separate from natural light.

21. The indicating device of claim 1, wherein a substrate has been coated with dyes that respond to different quantities of light energy impinging on them in a given period of time.

22. The indicating device of claim 4, further comprising a central bull's eye and a plurality of concentric bands or rings surrounding said bull's eye.

23. The indicating device of claim 5, wherein said stick has a plurality of bands sequentially applied in different locations.

24. The indicating device of claim 1, wherein said substrate is comprised of a polymer.

25. The indicating device of claim 24, wherein said polymer is selected from the group consisting of polymethylmethacrylate, polycarbonates, polystyrenes, polyolefins, polyacrylates, polyvinyl derivatives, polyester derivatives, polyvinyl chloride, cellulose derivatives, polyurethane, polyethylene terephthalate, silicone resins, triethylene glycol dimethacrylate, epoxy resins, taken alone or in combination thereof.

26. The indicating device of claim 24, wherein said substrate is formed by molding, pressing or casting.

27. The indicating device of claim 1, wherein said dyes are photochromic dyes.

28. The indicating device of claim 27, wherein said photochromic dyes are selected from the group consisting of spiropyrans, derivatives of spiropyrans, fulgides, ferrooxalates and diarylethenes, aromatic o-Nitro derivatives, 2,3,4,4-tetrachloro-1-oxo-1,4-dihydronaphthalen derivatives, Bis-Imidazoles derivatives, bis-pyrroles derivatives, and Azasuccinic anhydride derivatives.

29. The indicating device of claim 27, wherein said photochromic dyes are selected from the group consisting of 1,2-dibromotetrachlorethane, diphenylpicrylhydrazyl derivative, mercury dithizone, silver oxalate/mercurous oxalate mixture, and ferric oxalate.

30. The indicating device of claim 28, wherein said ferrooxalate is ferric oxalate.

31. The indicating device of claim 21, wherein said dyes are responsive to light energy in the ultraviolet spectrum, whereby they change color upon application of said light energy.
